(19) United States
(12) Patent Application Publication
(10) Pub. No.: US 2021/0133280 A1
(43) Pub. Date: May 6, 2021

(54) METHOD AND SYSTEM FOR AUTOMATED FORM FIELD DETECTION AND COMPLETION

(71) Applicant: INTUIT INC., Mountain View, CA (US)

(72) Inventors: Yair HORESH, Hod Hasharon (IL); Shlomi MEDALION, Lod (IL); Liron HAYMAN, Jerusalem (IL); Yehezkel S. RESHEFF, Hod Hasharon (IL)

(21) Appl. No.: 16/671,870

(22) Filed: Nov. 1, 2019

(51) Int. Cl. G06F 17/24

(52) U.S. Cl. CPC G06F 17/243

(57) ABSTRACT

Certain aspects of the present disclosure provide techniques for automatic form detection and completion. When a form is first identified by systems and methods disclosed herein, an image of the form is acquired and the form is uniquely identified. The image of the form is presented to a user, who clicks on areas of the form image and provides data into the areas so chosen. The coordinates of the user input in the form image, data provided by the user, and attributes of that data, are stored. Once a sufficient number of users, determined by a confidence interval threshold, have used the form in this manner, the user data input is clustered around user defined input coordinates. From the user data, a data schema of the user input is determined, and the data schema is assigned to the related user defined input coordinates. Once the data schema is assigned to user defined input coordinate and the next user interacts with the form, in some embodiments the data schema is matched to the user data of the next user, and the user data of the next user is automatically entered into the form at the coordinates.

### INTRODUCTION

Aspects of the present disclosure relate to automated form field detection and completion.

Filling out forms is a common task that is necessary in a variety of contexts, such as running a business, managing finances, purchasing and maintenance of goods/services, preparing and filing tax returns, obtaining a loan, filling out an invoice, and the like. The number and variety of forms, and the contexts in which they are employed, is boundless. Although necessary in these and other contexts, form-filling is seen as a low value-add activity: a user of the form provides known information to well-understood fields in the form that request that information.

In order to make form-filling easier, a form may be put through optical character recognition (OCR) to convert the physical form into an electronic one, relying on OCR to provide form information by reading and understanding text on the form. Because OCR is not perfect, any form that is OCR'ed typically requires a subject matter expert (SME) to review the form and provide corrections where needed. Additionally, if a form changes, the system relying upon prior OCR-based approaches will need to OCR the new form and have it reviewed by an SME, requiring additional time and expense.

Once properly OCR'ed, an electronic form is manually coded to receive user input of data requested by the form. Some have gone so far as to create applications specifically designed to retrieve user information to populate particular forms that have been OCR'ed. However, these applications are limited not only by the need for a SME to review the form, manual encoding of the form to retrieve data and populate the form with that data, but also in that these solutions are form-specific. They do not provide a general solution that can be applied to any form, and any number of different forms, without substantial costs in time, money, and other resources.

What is needed are a system and method to encode any form in a manner that does not rely on OCR to recognize text in a form, does not require SME review, enables automatic population of user data into a form, and avoids the cost and expense associated with prior approaches.

### BRIEF SUMMARY

Certain embodiments provide a method for automated form field detection and completion. The method generally includes receiving a form image representing a form, presenting the form image to a user, and receiving user input comprising user defined input coordinates in the form image, and input content, the input content comprising first user attribute data. In embodiments, the method includes mapping the first user attribute data to an attribute schema, and associating the attribute schema with the user defined input coordinates. In some embodiments the method may further include presenting the form image to a second user, mapping the attribute schema to second user attribute data, and modifying the form image to provide the second user attribute data at the user defined input coordinates.

Additional embodiments provide a system for automated form field detection and completion. The system includes a processor and a memory storing instructions which, when executed by the processor, perform a method for automated form field detection and completion. The method generally includes receiving a form image representing a form, presenting the form image to a user, and receiving user input comprising user defined input coordinates in the form image, and input content, the input content comprising first user attribute data. In embodiments, the method includes mapping the first user attribute data to an attribute schema, and associating the attribute schema with the user defined input coordinates. In some embodiments the method may further include presenting the form image to a second user, mapping the attribute schema to second user attribute data, and modifying the form image to provide the second user attribute data at the user defined input coordinates.

Further embodiments provide a non-transitory computer-readable medium comprising instructions that, when executed by a processor of a processing system, cause the processing system to perform a method for automated form field detection and completion. The method generally includes receiving a form image representing a form, presenting the form image to a user, and receiving user input comprising user defined input coordinates in the form image, and input content, the input content comprising first user attribute data. In embodiments, the method includes mapping the first user attribute data to an attribute schema, and associating the attribute schema with the user defined input coordinates. In some embodiments the method may further include presenting the form image to a second user, mapping the attribute schema to second user attribute data, and modifying the form image to provide the second user attribute data at the user defined input coordinates.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a system for automated form field detection and completion, according to disclosed embodiments.

FIG. 2 depicts a method for automated form field detection and completion, according to disclosed embodiments.

FIG. 3 depicts an example method for automated form field detection and completion.

FIG. 4 depicts an example processing system for automated form field detection and completion, according to disclosed embodiments.

To facilitate understanding, identical reference numerals have been used, where possible, to designate identical elements that are common to the drawings. It is contemplated that elements and features of one embodiment may be beneficially incorporated in other embodiments without further recitation. The appended drawings illustrate only typical embodiments of this disclosure and are therefore not to be considered limiting of its scope, for the disclosure may admit to other equally effective embodiments.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether a particular advantage is achieved by a given embodiment is not limiting of the disclosure. Thus, the following aspects, features, embodiments, and advantages are merely illustrative and are not considered elements or limitations of the appended claims except where explicitly recited in a claim. Likewise, reference to “the disclosure” shall not be construed as a generalization of any inventive subject matter disclosed herein and shall not be considered an element or limitation of the appended claims except where explicitly recited in the claim.

Aspects of the present disclosure provide apparatuses, methods, processing systems, and computer readable mediums for defining a form to provide support for automated filling of form fields.

In embodiments, when a form is first identified by systems and methods disclosed herein, an image of the form is acquired and the form is uniquely identified. The image of the form is presented to a user, who clicks on areas of the form image and provides data into the areas so chosen. The coordinates of the user input in the form image, data provided by the user, and attributes of that data, are stored. Once a sufficient number of users, determined by a confidence interval threshold, have used the form in this manner, the user data input is clustered around user defined input coordinates. From the user data, a data schema of the user input is determined, and the data schema is assigned to the related user defined input coordinates. Once the data schema is assigned to the user defined input coordinates and the next user interacts with the form, in some embodiments the data schema is matched to the user data of the next user, and the user data of the next user is automatically entered into the form at the coordinates.

### Example System for Automated Form Field Detection and Completion

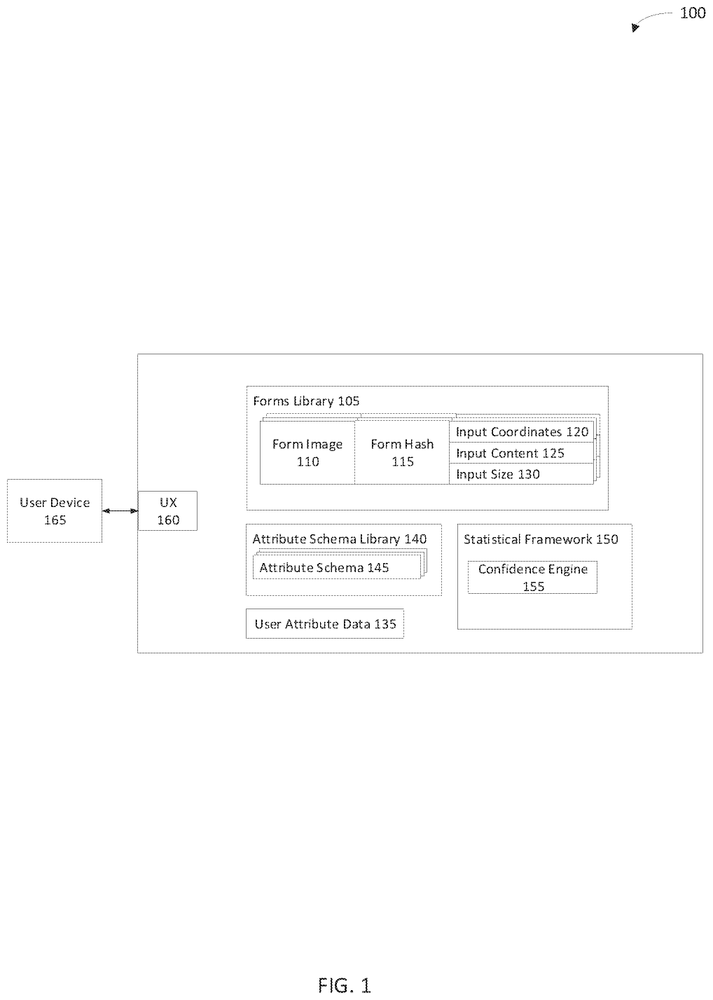

FIG. 1 depicts a system 100 for automated form field detection and completion.

In the depicted embodiment, a forms library 105 comprises multiple form images 110. A form image 110 is a representation of a form provided to the system 100 by either a user device 165 or another data source. A form image 110 may generally be of any format presentable via a computer system, including in any image format (e.g., .JPG, .PNG, .GIF, .TIFF, .XCG, .PSD, .PSB) or any format capable of displaying information on a user interface and utilizing layers in conjunction with the displayed information, either alone or with the assistance of an additional application or software. Non-image formats, such as document formats (e.g., .DOC, .DOCX, .PDF, .DTD, .SDB, .SDW), presentation formats (e.g., .PPT, .SDD, .ODP), and spreadsheet formats (e.g., .XLS, .XLSX, .ODS, .OTP), may also be provided and subsequently converted to a suitable image format.

In embodiments, a form from which form image 110 may be generated may include, for example, any type of form generated by a government, for-profit or non-profit business entity, school, business, individual, or more generally any document having at least a visual structure of data that requests data from a user.

Upon receipt of the form image 110, a form hash 115 unique to the form image 110 is generated. The form hash 115 may be generated by an application such as ImageHash, by Johannes Buchner, or other application or method known by one of skill in the art capable of creating a hash of the form image 110. The form hash 115 may be used as a unique identifier for the form image 110, or a separate identifier may be assigned.

When a user device 165 interacts with the form image 110 via a user experience (UX) 160, additional information is stored with the form image 110. In embodiments, user defined input coordinates 120 are associated with coordinates of the image for at which the user device 165 indicates placement of data in the form image 110. By way of example, this may be indicated by the click of a mouse, a touch of a touch screen, a voice command, or other direct or indirect indication of a choice of coordinates in the form image 110 received from the user device 165. For a given form image, there may be one or more user defined input coordinates 120 associated with a form image 110, reflecting one or more locations on the form at which the user device 165 places data, as many forms require more than one item of data. It is understood that the user defined input coordinates 120 are selected by the user based upon the visual structure of image 110.

By way of example, if the form image displays text indicating requested data next to a visual form field (e.g., an underline, a box, a row of boxes), it is left to the user where to enter the requested data—the location at which the user initiates entry of the requested data is stored as user defined input coordinates 120. As a number of form images 110 are stored for the same/similar form, a number of similar user defined input coordinates 120 will be collected for the same/similar data entry location.

Once user defined input coordinates 120 are indicated in form image 110, input content 125 may be received from the user device 165 at user defined input coordinates 120. The input content 125 may further be stored with the form image 110. As a number of form images 110 are stored for the same/similar form (e.g., associated with different users), a number of similar input content 125 entries at the same/similar user defined input coordinates 120 will be stored.

For each input content 125, an input size 130 is stored, reflecting the size of the input content 125 at input coordinate 120 in the form image 110, for example, in bytes, or other unit of data storage used by an operating system.

The input content 125 entered at user defined input coordinates 120 (e.g., by user device 165) may be any type of data associated with a form. For example, the user entering data via user device 165 may be entering data on her own behalf, or on behalf of an entity such as a business, a government, an educational facility, or any one of a variety of entities for which a person may operate.

User attribute data 135 in embodiments may be data representing attributes of a user, such as a name, address, phone number, email, date of birth, age, or other attribute related to the user, as well as attributes of the user's finances, business dealings, or any other aspects of the user and/or the activities the user is engaged in, or any user attribute data 135 that may be requested by a form represented by form image 110. User attribute data 135 in other embodiments may be data representing attributes of the entity whom a user is entering data on behalf of In such embodiments, user attribute data 135 may be related to finances, business dealings, or other activities in which the entity is engaged. These may include, for example, entity name, employees, invoice numbers, physical or capital resources, records of financial or business dealings, or any other user attribute data 135 that may be requested by a form represented by form image 110.

In some embodiments, attribute schema library 140 comprises a number of attribute schemas 145. Each attribute schema 145 generally represents a structure of data of a type of user attribute that may be entered as user attribute data 135, and in some embodiments how the user attribute relates to another element of data, such as another user attribute, or an attribute of a different person or entity. By way of example, the attribute schema 145 for user attribute data 135 representing an email address may by <text string>@<text string>.<top level domain name>, and similar attribute schema 145 are known to one of ordinary skill for other user attribute data 135 such as the name of a person, a business name, a birth date, today's date, financial data (income, revenue, debt, tax information, etc.

Statistical framework 150 comprises a confidence engine 155 to determine confidence intervals within the system 100 for a variety of actions including, for example, those set forth below. In embodiments, confidence engine 155 determines a confidence a confidence interval for a single mean, as is understood by one of skill in the art. The confidence interval is a range of values reflecting the percent chance that a value of a set of values will be selected. By way of example and discussed below, when a user selects a form the confidence engine 155 using the number of previous instances that the same/similar form has been filled out, determines if the confidence interval is sufficiently high, such that at least one field of the form may be automatically filled in for the user with the user's data. In other embodiments, confidence intervals may be determined by other methods as is understood by one of ordinary skill

### Example Method for Automated Form Field Detection and Completion

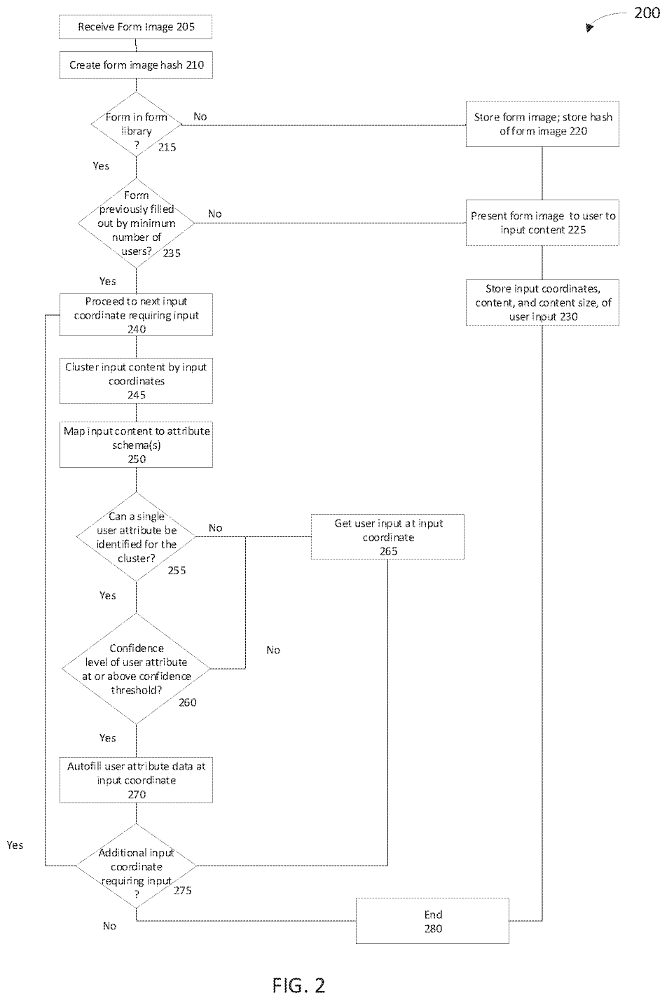

FIG. 2 depicts a method 200 for automated form field detection and completion.

At 205, form image is received from a user device such as user device 165 in FIG. 1, via a user interface, such as UX 160 described above with respect to FIG. 1. The user device may provide the form image directly as an image file, while in some embodiments user device may provide a non-image file that is subsequently converted to an image format.

At 210, a form hash is generated using the form image. As discussed above, the form hash may be generated by an application such as ImageHash or by other image hashing methods.

At 215 the system determines if the form image is in a form library, such as form library 105 described above with respect to FIG. 1. In some embodiments, this is accomplished by comparing the form hash of the form image against the hash of other form images. Hashes that are the same, or substantially similar may be determined to be the same form. If it is determined that the form image is not in the form library 105, then method 200 continues to 220. If the form image is determined to be in the form library, which indicates that the form image has previously received data (e.g., based on matching at least one of user defined input coordinates, input content, input size) at least once, then method 200 continues to 235.

At 220, the form image and form hash are stored, for example, in a database, or other suitable data store.

At 225, the form image is presented to a user. In embodiments, the form image is overlaid with an image layer capable of recording input received from a user device. Alternatively, the form image itself may receive input from a user device, and in these embodiments, a copy of the form image may be saved prior to receipt of input. Input received from the user device, for example, may be in the form of user defined input coordinates indicating a location on the form image. In some embodiments, user defined input coordinates may be received from a user device through an input device, such as a mouse or other pointing I/O device, and may alternatively or additionally be entered via a touchscreen or other touch-sensitive I/O device. In other embodiments, user defined input coordinates may alternatively, or additionally, be entered via voice or other touchless I/O.

At 230, the user defined input coordinates, input content, and input size are stored as part of the forms library or other suitable database. In embodiments, once there are no further user defined input coordinates received from user device, at 280, method 200 may end.

At 235, it is determined how many times data had previously been received for the form image. In some embodiments, this may include how many times data had been received for form images that are the same as/similar to the form image. In embodiments, the determination of similarity as between different form images is based upon the similarity of the form hash of each form image.

If the number of times data had previously been received for a form image, and in some embodiments similar form images, has a confidence interval that is below a threshold, then it may be determined that there is not yet sufficient data and more input is needed from users, causing method 200 to proceed to 225.

If the number of times data had previously been received for a form image is at or above the confidence interval threshold, there may sufficient data to automatically fill at least a portion of the form image from user attribute data 135, causing method 200 to proceed to 240.

At 240, method 200 proceeds to determine the next user defined input coordinates in the form image that require data.

At 245, for a set of same/similar user defined input coordinates of the form image (including that of similar form images), input content 125 is clustered for the same/similar user defined input coordinates.

At 250, the clustered input content is mapped to one or more attribute schema, such as attribute schema 145 described above with respect to FIG. 1. As above, an attribute schema 145 may indicate a structure of data, which in-turn defines the type of data. For example, an attribute schema defining a structure of data similar to <text string1>@<text string2>.<top-level domain>, may indicate an email address.

At 255, the confidence engine is used to determine a confidence interval based upon the number of occurrences of the attribute schema identified for user attribute data entered at the same/similar user defined input coordinates 120. If a single attribute schema is calculated to meet/exceed a confidence interval threshold, method 200 proceeds to 260. Otherwise, if the single attribute schema does not meet the confidence interval threshold, then method 200 proceeds to 265 to obtain user input at the user defined input coordinates.

At 260, confidence engine is used to determine a confidence interval based upon the number of instances of user attribute data that utilize the attribute schema identified at 255. If the confidence interval determined by confidence engine is sufficiently high, method 200 proceeds to 270, otherwise method 200 proceeds to 265 to obtain user input at the user defined input coordinates.

At 270, the attribute schema from 260 is matched to user attribute data to find the element of user attribute data that corresponds to attribute schema. The corresponding element of user attribute data is auto-filled at the user-defined input coordinates, automatically providing the corresponding user data at the user defined input coordinates of the form image for the user.

At 275, if there are additional user defined input coordinates of the form image that require data, method 200 proceeds to 240. If there are no further user defined input coordinates requiring data, method 200 ends at 280.

### Example Method of Automated Form Field Detection and Completion

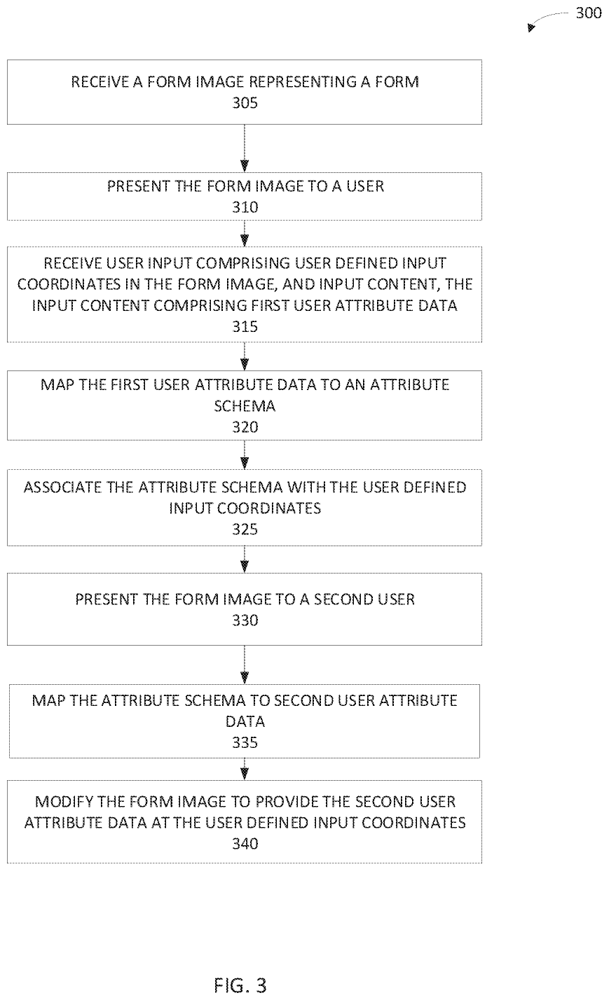

FIG. 3 depicts an exemplary method 300 for automated form field detection and completion.

Method 300 begins at 305 with receiving a form image representing a form. In some embodiments, receiving the form image comprises receiving a plurality of form images representing the same form/substantially the same form.

At 310 method 300 continues by presenting the form image to a user. In embodiments, presenting the form image to a user comprises presenting a respective one of the plurality of images to a respective one of a plurality of users.

Method 300 then continues to 315, receiving user input comprising user defined input coordinates in the form of image, and input content, the input content comprising first user attribute data. In some embodiments, receiving input user input comprises receiving input from the plurality of users comprising a plurality of substantially similar user defined input coordinates and a plurality of input content associated with the plurality of substantially similar user defined input coordinates.

Alternative embodiments further comprise mapping each of the plurality of input content to an attribute schema, while additional embodiments comprise clustering the plurality of input content based on the user defined input coordinates, and assigning the attribute schema to the input coordinates based on the plurality of input content. In further embodiments, attribute schema is assigned to the input coordinates if a confidence interval of the attribute schema meets a confidence threshold.

Additionally, a hash may be determined for each respective one of the plurality of form images, and the form images are determined to represent substantially the same form by comparing the hash of each respective one of the plurality of form images.

At 320 the method 300 continues by mapping the first user attribute data to an attribute schema.

The method 300 may then proceed to 325, associating the attribute schema with the user-defined input coordinates.

The method 300 may then proceed to 330, presenting the form image to a second user.

The method 300 may then proceed to 330, mapping the attribute schema to second user data, and at 335, modifying the form image to provide the second user attribute data at the user-defined input coordinates.

### Exemplary Processing System

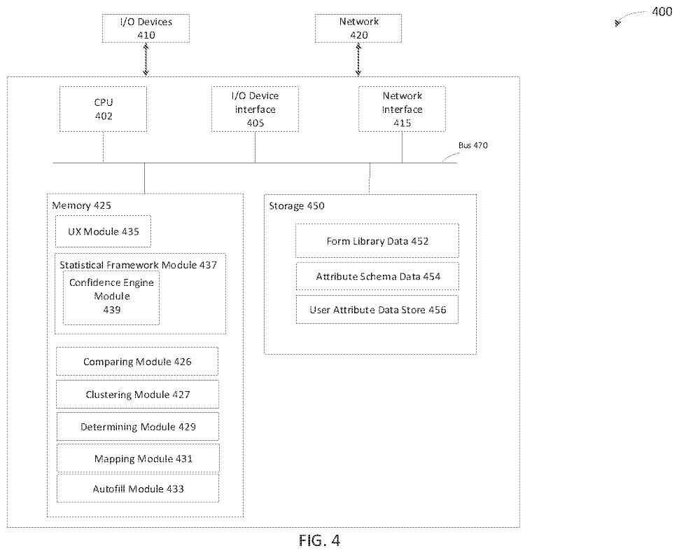

FIG. 4 depicts an exemplary processing system 400 for implementing the system of FIG. 1 and/or carrying out the method of FIG. 2, as well as other operations describe herein.

Processing system 400 includes a CPU 402 connected to a bus 470. CPU 402 is configured to process computer-readable instructions, such as stored in memory 425 and/or storage 450, and to cause processing system 400 to perform methods as described herein, for example with respect to FIG. 2. CPU 402 is included to be representative of a single CPU, multiple CPU's, a single CPU having multiple processing cores, and other forms of processing architecture capable of executing computer-readable instructions. In some embodiments, CPU 402 may be located, in whole or in part, remotely and accessed vie a network.

Processing system 400 includes an I/O device interface 405 to provide access to I/O devices 410 and a network interface 415 to provide access to a network 420.

Processing system 400 further includes a memory 425, which in embodiments includes a plurality of modules.

By way of example, memory 425 includes a comparing module that is configured to perform comparing operations as described above (e.g., with respect to FIG. 2).

Memory 425 further includes a clustering module 427 that is configured to perform clustering operations as described above.

Memory 425 further includes a determining module 429 configured to perform determining operations as described above.

Memory 425 further includes a mapping module 431 configured to perform mapping operations as described above.

Memory 425 further includes an autofill module 433 configured to perform autofill operations as described above.

Memory 425 further includes a UX module 435 configured to perform user interface operations in relation to a user device, for example as described above with respect to FIGS. 1 and 2.

Memory 425 further includes a statistical framework module 437 that comprises at least a confidence engine module 439 configured to perform confidence interval operation as described above.

Note that while shown as a single memory 425 in FIG. 4 for simplicity, the various aspects stored in memory 425 may be stored in different physical memories, but all accessible to CPU 402 via internal data connections such as bus 470. Alternatively, various aspects stored in memory 425 may be stored in one or more physical memories located outside of processing system 400 and accessed via the network 420.

Processing system 400 further includes a storage 450, which in embodiments includes form library data store 452. Form library data store may further comprise form library data 452 which may be related to forms library 105, form image 110, form hash 115, and at least one of user defined input coordinates 120, input content 125, and input size 130, as described above with respect to FIGS. 1 and 2.

Storage 450 may further include attribute schema data 454, that may be related to attribute schema library 140, and its contents such as attribute schema 145, as described above with respect to FIGS. 1 and 2.

Storage 450 may further include user attribute data store 456, which may be related to user attribute data 135 of FIG. 1, and related to the method discussed above in connection with FIG. 2.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automated form field detection and completion, comprising:
receiving a form image representing a form;
presenting the form image to a user;
receiving user input comprising input content and user defined input coordinates in the form image, the input content comprising first user attribute data;
mapping the first user attribute data to an attribute schema;
associating the attribute schema with the user defined input coordinates;
presenting the form image to a second user;
mapping the attribute schema to second user attribute data; and
modifying the form image to provide the second user attribute data at the user defined input coordinates.

2. The method of claim 1, wherein:
receiving the form image comprises receiving a plurality of form images representing substantially the same form, and
presenting the form image to a user comprises presenting a respective one of the plurality of images to a respective one of a plurality of users; and
receiving the user input comprises receiving input from the plurality of users, the input comprising a plurality of substantially similar user defined input coordinates and a plurality of input content associated with the plurality of substantially similar user defined input coordinates.

3. The method of claim 2, further comprising: mapping each of the plurality of input content to an attribute schema.

4. The method of claim 3, further comprising: clustering the plurality of input content, based on the user defined input coordinates.

5. The method of claim 4, wherein associating the attribute schema with the user defined input coordinates comprises: assigning the attribute schema to the user defined input coordinates based on the plurality of input content.

6. The method of claim 5, wherein the attribute schema is assigned to the user defined coordinates if a confidence interval of the attribute schema meets a confidence threshold.

7. The method of claim 2 wherein: a hash is determined for each respective one of the plurality of images, and the images are determined to represent substantially the same form by comparing the hash of each respective one of the plurality of images.

8. A system, comprising:
a processor; and
a memory storing instructions which when executed by the processor perform a method for automated form field detection and completion, the method comprising:
receiving a form image representing a form;
presenting the form image to a user;
receiving user input comprising user defined input coordinates in the form image, and input content, the input content comprising first user attribute data;
mapping the first user attribute data to an attribute schema;
associating the attribute schema with the user defined input coordinates;
presenting the form image to a second user;
mapping the attribute schema to second user attribute data; and
modifying the form image to provide the second user attribute data at the user defined input coordinates.

9. The system of claim 8, wherein:
receiving the form image comprises receiving a plurality of form images representing substantially the same form, and
presenting the form image to a user comprises presenting a respective one of the plurality of images to a respective one of a plurality of users, and receiving user input comprises receiving input from the plurality of users comprising a plurality of substantially similar user defined input coordinates and a plurality of input content associated with the plurality of substantially similar user defined input coordinates.

10. The system of claim 9, further comprising: mapping each of the plurality of input content to an attribute schema.

11. The system of claim 10, further comprising: clustering the plurality of input content, based on the user defined input coordinates.

12. The system of claim 11, further comprising: assigning the attribute schema to the input coordinates based on the plurality of input content.

13. The system of claim 12, wherein the attribute schema is assigned to the form coordinates if a confidence interval of the attribute schema meets a confidence threshold.

14. The system of claim 9 wherein: a hash is determined for each respective one of the plurality of images, and the images are determined to represent substantially the same form by comparing the hash of each respective one of the plurality of images.

15. A non-transitory computer-readable medium comprising instructions that, when executed by a processor of a processing system, cause the processing system to perform a method for automated form field detection and completion, the method comprising:
receiving a form image representing a form;
presenting the form image to a user;
receiving user input comprising user defined input coordinates in the form image, and input content, the input content comprising first user attribute data;
mapping the first user attribute data to an attribute schema;
associating the attribute schema with the user defined input coordinates;
presenting the form image to a second user;
mapping the attribute schema to second user attribute data; and
modifying the form image to provide the second user attribute data at the user defined input coordinates.

16. The computer-readable medium of claim 15, wherein:
receiving the form image comprises receiving a plurality of form images representing substantially the same form, and
presenting the form image to a user comprises presenting a respective one of the plurality of images to a respective one of a plurality of users, and receiving user input comprises receiving input from the plurality of users comprising a plurality of substantially similar user defined input coordinates and a plurality of input content associated with the plurality of substantially similar user defined input coordinates.

17. The computer-readable medium of claim 16, wherein the method further comprises: mapping each of the plurality of input content to an attribute schema.

18. The computer-readable medium of claim 17, wherein the method further comprises: clustering the plurality of input content, based on the user defined input coordinates.

19. The computer-readable medium of claim 18, wherein the method further comprises: assigning the attribute schema to the input coordinates based on the plurality of input content.

20. The computer-readable medium of claim 19, wherein the attribute schema is assigned to the form coordinates if a confidence interval of the attribute schema meets a confidence threshold.
